(19) United States
(12) Patent Application Publication
(10) Pub. No.: US 2010/0053711 A1
(43) Pub. Date: Mar. 4, 2010

(54) DEVICE FOR SELECTION OF LIGHT IN A REFRACTION ARRANGEMENT

(76) Inventor: Ralf Haussler, Dresden (DE)

Correspondence Address: Saul Ewing LLP (Philadelphia), Attn: Patent Docket Clerk, 2 North Second St., Harrisburg, PA, 17101, US

(21) Appl. No.: 12/374,673

(22) PCT Filed: Jun. 25, 2007
(86) PCT No.: PCT/EP2007/056297

§ 371 Date: Oct. 6, 2009

(30) Foreign Application Priority Data
Jul. 1, 2006 (DE) 102006030503.5

(51) Int. Cl. G02B 5/32

(52) U.S. Cl. 359/15

(57) ABSTRACT

A device for the selection of light of at least one diffraction order comprises a light modulator device comprising a hologram. The light modulator device emits modulated light, where the light comprises one beam which is not deflected by the hologram and at least one diffracted beam. The device comprises at least one controllable angle-selective optical element which selects the light of diffraction orders.

The present invention relates to a device for the selection of light of at least one diffraction order, which is emitted after modulation by a light modulator device having a hologram, where the light has one beam which is not deflected by the hologram and at least one diffracted beam.

In holography, when reconstructing two- and/or three-dimensional scenes, illuminating light is modulated by a light modulator device which contains a hologram. For example, if the Burckhardt encoding method is used, a modulated light beam has three components: light of the zeroth diffraction order and light of the 1^{st} and −1^{st} diffraction orders. The light of the zeroth diffraction order is not diffracted, it propagates along the same path as the incident beam and does not contain any information about a scene. Light of the 1^{st} and −1^{st} diffraction order is diffracted light, and reconstructs the scene. Further, there are components of higher diffraction orders, which normally only contribute a small portion to the total sum of diffracted light. However, undesired diffraction orders cause multiple reconstructions, which may overlap and which are thus perceived as disturbances by an observer. These disturbing multiple reconstructions must thus be eliminated by way of filtering the diffraction orders. It has already been proposed to use shutters to achieve this, but such shutters require intermediate projection. Moreover, the shutters themselves may be perceived by the observer as disturbing, because they are disposed between the light modulator device and the observer. Moreover, it is also possible to locate the observer eyes in regions where no undesired diffraction orders are visible.

For example, U.S. Pat. No. 4,810,047 proposes an optical system for the elimination of the zeroth diffraction order which contains a holographic lens, a polarisation rotator and a polarisation filter. The holographic lens is illuminated with a reconstruction beam such that it transmits a focused light beam along the optical axis of the lens, and a zeroth-order light beam. The two light beams are directed at the polarisation rotator, where the focused light beam is incident on the polarisation rotator under a different angle than the zeroth-order light beam. Thereby the zeroth-order light beam and the focused beam have different polarisation states or polarisation orientations.

The polarisation filter, which is disposed downstream the polarisation rotator, only transmits the focused light beam and attenuates or blocks the zeroth-order beam.

U.S. Pat. No. 6,091,521 describes another way of eliminating the zeroth diffraction order. The device has, in addition to the light modulator device, holographic optical elements (HOE) for the deflection of a light beam of one of the two first diffraction orders (1^{st} and −1^{st} diffraction order) such that the light beams of the first diffraction orders can be separated from the light beam of the zeroth diffraction order. The device has three HOEs, which exhibit fixed diffraction properties for the three primary colours, red, green and blue. For each light pencil which is emitted by the pixels of the light modulator device, the HOEs are holographically designed such that they deflect a light beam of only one of the two first diffraction orders such that the deflected light beam of the first diffraction order propagates in the same direction as the other, non-deflected light beam of the first diffraction order. The zeroth-order beam is incident on a light trap, which absorbs the light beam. This way the light beams of the first diffraction order are separated from the light beam of the zeroth diffraction order.

However, this device for the elimination of the zeroth diffraction order has the disadvantage that due to the small diffraction angles of the light modulator device the distance between the light modulator device and the light trap is very large. This makes the device is very large and it is rather difficult to use it in video projectors and TV sets.

It is thus an object of the present invention to provide a device for the elimination of light of at least one diffraction order, said device being in particular capable of avoiding the occurrence of multiple repetitions in a holographic reconstruction of a scene, and said device being easy to manufacture and having a compact design.

According to the present invention, this object is solved by providing at least one controllable angle-selective optical element which selects the light of diffraction orders.

The inventive device for the selection and elimination of light of at least one diffraction order has, in addition to a light modulator device, at least one angle-selective optical element. The light modulator device contains an encoded hologram with the help of which the light incident on the light modulator device is modulated according to a scene. This modulated light has a beam which is not deflected by the hologram, and at least one diffracted beam. The modulated light, which contains several diffraction orders, is incident on the angle-selective optical element. The element is called angle-selective because it is disposed in a section of the inventive device in which the diffraction orders exhibit different angles. In such a section, the light of the desired or undesired diffraction orders is separated with the help of the angle-selective optical element. The desired or undesired diffraction orders are preferably selected sequentially. Further, the angle-selective optical element is of a configurable design.

The inventive device can thus be used to block or to attenuate multiple repetitions of the reconstructed scene. One or multiple observers can thus watch a reconstructed scene, in particular a three-dimensional reconstructed scene, without disturbances and at high quality. Moreover, a further advantage of the inventive device is that it only requires little space compared with the device described in U.S. Pat. No. 6,091,521, which makes it suitable for use in video projectors, TV sets, telecommunications appliances and other applications which only provide limited space. Moreover, thanks to the configurability of the angle-selective optical element, it is possible to enlarge an angular range of the light modulator device, and thus to provide an enlarged reconstruction of the scene. This can be achieved in particular in conjunction with conventional light modulator devices.

According to a preferred embodiment of the present invention, the angle-selective optical element can have two semi-reflective layers, between which a transparent layer is disposed, preferably a liquid crystal layer. In particular the use of a liquid crystal layer makes it possible to provide a configurable angle-selective optical element, or to adapt the angle-selective optical element to the desired condition.

According to another preferred embodiment of the invention the diffracted beam can be reflected several times at the semi-reflective layers so that it passes the liquid crystal layer or transparent layer several times, respectively, whereby the reflected beams are subject to destructive interference. Multiple reflections of the light beams occur between the semi-reflective layers. Depending on the optical thickness of the transparent layer or liquid crystal layer and the angle at which a light beam is incident on the angle-selective optical element, there may be constructive or destructive interference of the beams. Because the diffraction orders differ in this angle, it can be defined which orders are transmitted and which are eliminated by choosing the optical thickness accordingly. The optical thickness of the liquid crystal layer or transparent layer and the reflectance of the semi-reflecting layers determine the filtering characteristic of the angle-selective optical element, i.e. the angular range of transmission or elimination and the filter steepness. Periodic repetitions of the scene can be avoided by choosing these parameters accordingly. This way undesired light of a diffraction order can be extinguished and thus eliminated, for example.

According to another preferred embodiment of the invention, in order to change the filtering characteristic, at least two angle-selective optical elements can be provided, the two angle-selective optical elements having different optical thicknesses of the transparent layers or liquid crystal layers and/or in the reflectance of the semi-reflective layers. A desired filtering characteristic can be realised with greater precision by combining multiple angle-selective optical elements. The angle-selective optical elements can differ in their optical thickness and reflectance, so that the desired angular range of transmission or extinction and the filter steepness is achieved by multiplication of the different filtering characteristics. This provides for a specific transmission or extinction of diffraction orders.

It is further possible to use a birefringent material for the angle-selective optical element, where a polarisation filter is provided for the elimination of an undesired diffraction order.

Other embodiments of the invention are defined by the other dependent claims. Embodiments of the present invention are explained in detail below and illustrated in conjunction with the accompanying drawings. The principle of the invention will be explained based on a partial holographic reconstruction with monochromatic light. However, it appears to those skilled in the art that this invention may as well be applied if coloured light is used, as indicated in the description of the individual embodiments.

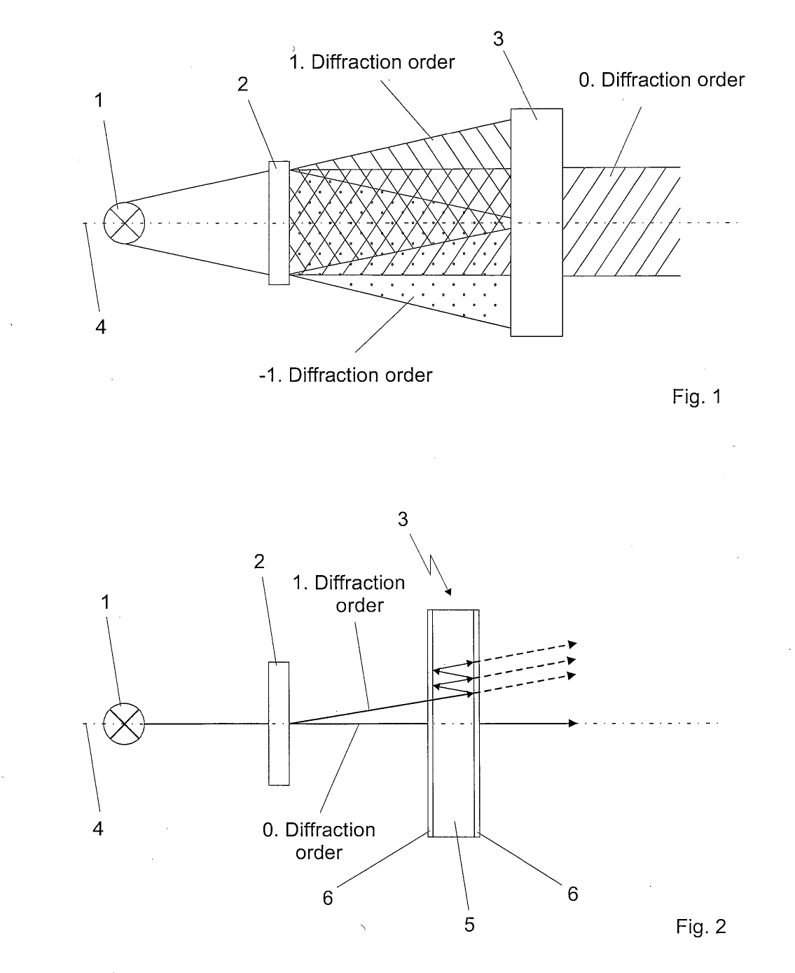

FIG. 1 shows a schematic diagram of an inventive device with an angle-selective optical element for the elimination of light of a diffraction order.

FIG. 2 shows a schematic diagram of a first embodiment of the inventive angle-selective optical element.

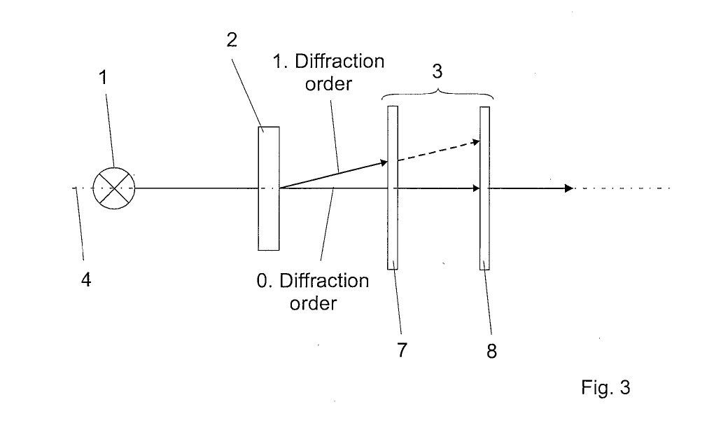

FIG. 3 shows a second embodiment of the angle-selective optical element.

During the holographic reconstruction of scenes the reconstructed scene is repeated periodically, because the object information is encoded in pixels of the light modulator device. The light which is thus modulated and diffracted by the pixels interferes and creates intensity maxima and minima in certain directions starting on the light modulator device. One of those maxima, generally the one with the same orientation as the incident beams, is the main maximum, also called the zeroth diffraction order. The two adjacent maxima are known as the 1^{st} and the −1^{st} diffraction order. Accordingly, the further adjacent maxima are defined as higher diffraction orders. The thus occurring periodic repetitions during the holographic reconstruction of scenes can disturb an observer of the reconstructed scenes.

Which diffraction order is used for the holographic reconstruction of a scene is depending on the characteristic of the light modulator device. The zeroth diffraction order is typically used in phase-modulating devices, and the 1^{st} or −1^{st} diffraction order is typically used in amplitude-modulating devices. The following embodiments relate to a reconstruction in the zeroth diffraction order. However, the principle can as well be applied to other diffraction orders.

FIG. 1 shows a device for the elimination of undesired light of at least one diffraction order. The device has an illumination unit 1, a light modulator device 2 and an angle-selective optical element 3. The illumination unit 1 and the light modulator device 2 may be of various types. No particular type is specified in the described embodiments. Such a device can for example be used in a projection device for holographic reconstruction of particularly three-dimensional scenes. It is of course also possible to use the device in other applications where undesired light is to be eliminated. After modulation, diffracted and non-diffracted light is emitted by the light modulator device 2. The different diffraction orders differ in their diffraction angles, i.e. light of the 1^{st} diffraction order exits the light modulator device 2 at an angle which is different from the angle at which light of the 0^{th} or 2^{nd} diffraction order is emitted, for example. FIG. 1 only shows the 0^{th}, 1^{st} and −1^{st} diffraction order. If illuminated with parallel light, the light of the 0^{th} diffraction order has a direction of 0°, while the light of the 1^{st} and of the −1^{st} diffraction order has other directions, respectively, and propagates at another angle towards the angle-selective optical element 3.

As shown in this embodiment, the light beams of the zeroth, 1^{st} and −1^{st} diffraction order are incident on the angle-selective optical element 3 after passage through the light modulator device 2. This angle-selective optical element 3 is designed such that it transmits light of the zeroth diffraction order and absorbs light of the 1^{st} and −1^{st} diffraction order. It is further possible that light of the 1^{st} and −1^{st} diffraction order is reflected by the angle-selective optical element 3 and directed to a light trap for elimination, for example. Light beams of the 1^{st} and −1^{st} diffraction order can thus be extinguished or eliminated. Of course, light of the zeroth diffraction order or light of higher diffraction orders can be eliminated the same way. The angle-selective optical element 3 is designed such that only light of one diffraction order is transmitted. This means that for the elimination of light of other diffraction orders, additional, differently designed angle-selective optical elements are required, respectively. However, in order to avoid this considerable effort, it is further possible to tilt the angle-selective optical element 3 in relation to an optical axis 4 of the device, depending on the diffraction order which is undesired and which is to be eliminated.

The angle-selective optical element 3 can for example be a filter, in particular a bandpass, high-pass or low-pass filter. The characteristic of the angle-selective optical element 3 allows specifically selecting, extinguishing or deflecting light beams of certain diffraction orders. Further, the desired characteristic of the angle-selective optical element 3 may be achieved by combining several individual angle-selective optical elements 3 which differ in their transmission. For a colour reconstruction of scenes, undesired light of a certain diffraction order must be eliminated separately for each monochromatic colour of light, because each angle-selective optical element 3 is adapted to a certain wavelength λ of light.

The angle-selective optical element 3 can be designed in various ways, as is shown in the following embodiments according to FIGS. 2 and 3.

Referring to FIG. 2, the angle-selective optical element 3 has a transparent plate 5, in particular a glass plate having surfaces, which are coated with semi-reflective layers 6. The light modulated by the light modulator device 2 is incident on the angle-selective optical element 3, where in this embodiment the zeroth and the 1^{st} diffraction orders are shown. Multiple reflections of the light beams occur between the semi-reflective layers 6. During each reflection, the light beam is partly reflected and partly transmitted. The transmitted beams, here indicated by a broken line, interfere in a multiple-beam interference, which is constructive or destructive, depending on the phase shift, or the difference in optical distance. This difference in optical distance depends on the optical thickness of the angle-selective optical element 3 and the angle at which the beams are incident on the element. At a difference in optical distance of λ/2, or a phase shift of π, the interference is destructive, while at a difference in optical distance of λ, or a phase shift of 2π, the interference is constructive. The same applies for differences in optical distance or phase shifts to which integer multiples of λ or 2π, respectively, are added or subtracted. Because of the dependence on the angle of incidence, there is constructive interference for the zeroth diffraction order and destructive interference for the 1^{st} and −1^{st} diffraction orders, as shown in the Figure, if the optical thickness of the angle-selective optical element 3 is chosen accordingly.

The degree of extinction depends on the reflectance of the semi-reflective layers 6. The higher the reflectance the greater is the degree of extinction in the angular ranges with destructive interference. Likewise, the higher the reflectance the higher is the steepness of the margins of the filtering characteristic, i.e. the sharper the separation between the angular ranges of transmission and extinction. The disadvantage of a great reflectance is, however, that the angular range in which the angle-selective optical element 3 transmits becomes smaller. A compromise must thus be found between the transmission of the zeroth diffraction order and the extinction of the 1^{st} and −1^{st} diffraction order by adjusting the reflectance accordingly.

An angular range which exhibits destructive interference in transmission, will exhibit constructive interference for the reflected beam. It is thus also possible to use the angle-selective optical element 3 for reflection instead of transmission. In that case, the optical thickness and the reflectance must be chosen such that the desired diffraction order exhibits constructive interference in reflection. The observer then sees the desired diffraction order after reflection at the angle-selective optical element 3.

The multiple-beam interference at an angle-selective optical element 3 which has two semi-reflective layers will not only have one angular range of transmission and one angular range of extinction, respectively. Because the interferences of the multiple-reflected beams exhibit a periodicity with a phase shift of 2π, angular ranges of transmission and of extinction are repeated periodically. It is thus difficult to use the angle-selective optical element 3 to select only one diffraction order for transmission or extinction.

However, in order to achieve this, multiple angle-selective optical elements 3 can be provided. If multiple angle-selective optical elements 3 are disposed one behind another in the direction of light propagation, the filtering characteristics are multiplied. By adequate combination of different optical thicknesses of the transparent plate 5 and reflectances of the semi-reflective layers 6 of the individual angle-selective optical elements 3 it can thus be achieved, for example, to select only one diffraction order for transmission. It is also possible to combine multiple angle-selective optical elements 3, which are used partly for reflection and partly for transmission. It must be noted that one diffraction order stretches across an angular range. Therefore it is the aim to achieve a transmission which is as constant as possible within this angular range and a filtering characteristic which is as steep as possible at the margins.

Multiple-beam interference was described with an angle-selective optical element 3 which is coated with a semi-reflective layer 6 on each surface. However, each surface of the angle-selective optical element 3 can instead be coated with a multi-layer system. The multi-layer system comprises several layers lying upon each other, the layers differ in thickness and/or refractive index. These thicknesses and refractive indices can be combined such that the angular range of transmission or extinction and the steepness of the filtering characteristic at the margins of that range are adapted as desired.

The filtering characteristic of the angle-selective optical element 3 can alternatively be modified by tilting the angle-selective optical element 3 in relation to the optical axis 4, i.e. by changing the angle between the angle-selective optical element 3 and the optical axis 4.

An angle-selective optical element of that design has the advantages that it is of light weight and can be manufactured at relatively low cost and in large sizes.

Another design of the embodiment of the angle-selective optical element 3 according to FIG. 2 is described below. Such an angle-selective optical element 3 can also be made tunable in order to obtain a variable selection of diffraction orders. For this, instead of the transparent plate 5 a liquid crystal layer is disposed between the semi-reflective layers 6. If an electric field is applied to the liquid crystal layer 5, the refractive index of the liquid crystal layer 5 and thus the optical properties of the angle-selective optical element 3 can be controlled and modified. This way the optical thickness is changed by modifying the refractive index. This allows shifting the angular range which selects diffraction orders for transmission or extinction, respectively.

This controllable selection of diffraction orders allows for example in a projection device for holographic reconstruction of scenes a sequential reconstruction of a scene in several diffraction orders. For this, the angle-selective optical element 3 is for example controlled such that it transmits the zeroth diffraction order, and a part of the scene is reconstructed in the zeroth diffraction order. Then, the angle-selective optical element 3 is controlled such that is transmits the first diffraction order, and another part of the scene is reconstructed in the first diffraction order. Because the zeroth and the first diffraction orders differ in their angle and thus in the position of the corresponding reconstruction, the reconstructed scene as a whole becomes larger. This method can also be applied to further diffraction orders. If the sequential reconstruction of the scene is performed at a sufficiently high rate, i.e. about 25 Hz, the eye perceives a composite reconstruction. The reconstruction is thus no longer limited to one diffraction order.

The sequential reconstruction can for example be applied to the device and method disclosed in DE 103 53 439. This way, an observer window can be expanded to more than one diffraction order.

FIG. 3 shows another embodiment of the angle-selective optical element 3 in conjunction with the device for the elimination of light of at least one diffraction order. In this embodiment, the angle-selective optical element 3 has a body 7 of birefringent material, and a polarisation element 8. The polarisation element 8 can be a polarisation filter. The body 7 of birefringent material refracts an incident light beam so to form two different sub-beams (an ordinary and an extraordinary beam). The sub-beams exhibit perpendicular polarisation and different refractive indices. The birefringent body 7 is thereby of a uniaxial type, and the axis of the body 7 runs parallel to the optical axis 4 of the device. However, of course it is also possible to use a different birefringent body.

The device operates as follows in order to eliminate light of an undesired diffraction order. The light emitted by the light source 1 is directed to the light modulator device 2, where it is modulated. In the process of this modulation the light is split into several light pencils of different diffraction orders. For the sake of simplicity, only two light beams, of the zeroth and of the first diffraction order, are shown in FIG. 3. The two light beams of different diffraction orders are emitted by the light modulator device 2 at different angles, as described above. These light beams have the same polarisation state. The light beams of the zeroth and first diffraction orders then hit the birefringent body 7, i.e. they enter the birefringent body 7 at different angles. Because the axis of the birefringent body 7 is parallel to the light beam of the zeroth diffraction order in this embodiment, and this light beam hits a surface of the birefringent body 7 at a right angle, there is no spatial split into ordinary and extraordinary light. This means that the birefringent body 7 does not affect the orientation of the polarisation of the zeroth-order light beam. The light exits the birefringent body 7 with the same orientation of polarisation as it enters the body. However, the light of the first diffraction order hits the birefringent body 7 at an angle, so that it is split into an ordinary and an extraordinary beam. The two sub-beams exhibit different velocities of propagation, so that one sub-beam hurries ahead the other. Once both sub-beams have passed through the birefringent body 7, a retardation has established between them, which causes a change of the polarisation state of the transmitted light compared with the entering light of the first diffraction order. Thus, the light beams of the zeroth and first diffraction order which are emitted by the birefringent body 7 exhibit different polarisation states, e.g. linear-polarised light. These light beams then hit the polarisation element 8, which is disposed downstream. The polarisation element 8 is designed such that it only transmits light of the desired diffraction order, in this embodiment light of the zeroth diffraction order, as can be seen in the Figure. According to this embodiment, the light of the 1^{st} diffraction order is not desired and is absorbed or blocked by the polarisation element 8. If the axis of the birefringent body 7 is not parallel to the optical axis of the device, but at a right angle to it, dimension and properties of the birefringent body 7 must be chosen such that the emitted light beams of the zeroth diffraction order and of the first diffraction order exhibit different polarisation states.

It is of course also possible to use the birefringent body 7 to achieve other polarisation states, e.g. elliptically polarised light. However, such light cannot be selected using a linear polarisation element 8, as in the above embodiment. Other suitable polarisation elements, such as λ/4 plates for example, must then be provided for selection. Further, it is possible to combine or conjoin the birefringent body 7 and polarisation element 8 directly.

According to another embodiment, the angle-selective optical element 3 is of a configurable type for the selection of light of the desired diffraction order(s). For this, the controllable birefringent body 7 may for example be used as polarisation rotator, which is used to adequately rotate the polarisation of light of a certain diffraction order, and subsequently a polarisation element 8, e.g. a polarisation filter transmits the light. Such a controllable polarisation rotator can for example be a liquid crystal element (LCD). The polarisation rotations can be controlled by changing the voltage applied to the birefringent body 7. This way, the light beams of the individual diffraction orders can be selected sequentially and light beams of undesired diffraction orders can be eliminated.

It is also possible to combine the polarisation element 8 and a controllable polarisation rotator 7 so to form one unit. The polarisation element 8 is then a liquid crystal element (LCD) which operates such that the light of an undesired diffraction order is blocked or absorbed. The polarisation element 8 can for example operate like an IPS-LCD (in-plane switching LCD). With such a polarisation element 8 the liquid crystal molecules are oriented in one plane, and rotate in this plane if a voltage is applied. This effects a λ/2 retardation between the ordinary and the extraordinary beam. Linear polarised light is thereby rotated, for example, and the light of the undesired diffraction order is then blocked.

The angle-selective optical element 3 can also be of a configurable type, by providing a rotatable polarisation element 8 in combination with a birefringent body 7. Due to the fact that the polarisation element 8 is rotatable, light of the different diffraction orders can also be individually selected and eliminated sequentially this way. It is of course again possible to use the birefringent body 7 to achieve other polarisation states.

With the help of the above-described embodiments of an angle-selective optical element 3 it is for example possible to enlarge a useful angular range of the light modulator device 2, if this element is used in a device for the holographic reconstruction of scenes. More specifically, one part of the scene is reconstructed in the zeroth diffraction order, and another part of the scene is subsequently reconstructed in the first diffraction order. Depending on the desired size of the reconstruction, this can be repeated with several diffraction orders. It is thereby necessary that the switching from one part of the scene to the next part is fast enough, whereby the size of the reconstructed scene can be affected or the reconstructed scene can be enlarged. If this is the case, the observer can watch a large scene, for example a three-dimensional scene, in several diffraction orders.

In all embodiments it is also possible to use small light modulator devices, such as LCoS (liquid crystal on silicon) or MEMS (micro electro mechanical system). This allows using accordingly small angle-selective optical elements 3. The required birefringent bodies 7 or transparent plates or liquid crystal layers 5 can then have apertures of about 10 mm. Further, it is much easier to realise angle-selective optical elements 3 of such small size.

Possible applications of the inventive device for the elimination of light of at least one diffraction order are, for example, holographic projection devices for a two- and/or three-dimensional representations in private or working environments, for instance computers, mobile phones, TV, electronic games, automotive industry for displaying information, or in the entertainment industry, in medical engineering or as well in military engineering for the representation of surface profiles, for example. Of course the present device can also be applied in other areas, not mentioned above, where light of certain diffraction orders is to be selected or eliminated.

1. Device for the selection of light of at least one diffraction order, the device comprising a light modulator device having a hologram and least one controllable angle-selective optical element, where the light that propagates from the light modulator device has one beam which is not deflected by the hologram and at least one diffracted beam, characterised in that the at least one controllable angle-selective optical element is transmissive for only one diffraction order for selecting the light of diffraction orders.

2. Device according to claim 1, characterised in that the angle-selective optical element selects the light of diffraction orders sequentially.

3. Device according to claim 1, characterised in that the angle-selective optical element has two semi-reflective layers and a transparent layer in between.

4. Device according to claim 3, characterised in that the transparent layer is made of liquid crystals.

5. Device according to claim 4, characterised in that the optical property of the liquid crystal layer is controllable.

6. Device according to claim 3, characterised in that the diffracted beam is reflected several times at the semi-reflective layers so that it passes the transparent layer or the liquid crystal layer several times, respectively, whereby the reflected beams are subject to destructive or constructive interference.

7. Device according to claim 6 characterised in that for changing the filtering characteristic at least two angle-selective optical elements are provided.

8. Device according to claim 7, characterised in that the two angle-selective optical elements exhibit different optical thicknesses of the transparent layer or liquid crystal layer and/or different reflectance of the semi-reflective layers.

9. Device according to claim 7, characterised in that the two angle-selective optical elements are arranged at different angles to an optical axis.

10. Device according to claim 1, characterised in that the angle-selective optical element can be made of a birefringent material, which comprises a polarisation element for the elimination of an undesired diffraction order.

11. Device according to claim 10, characterised in that the polarisation element is rotatable.

12. Device according to claim 10, characterised in that the birefringent material of the angle-selective optical element is made of liquid crystals.

13. Device according to claim 10, characterised in that the angle-selective optical element is combined with a polarisation element, which contains liquid crystals for controllably changing the polarisation state of the light.

14. Device according to claim 12, characterised in that the angle-selective optical element is combined with a polarisation element, which contains liquid crystals for controllably changing the polarisation state of the light.
